(19) United States
(12) Patent Application Publication
(10) Pub. No.: US 2006/0101960 A1
(43) Pub. Date: May 18, 2006

(54) Optical proximity device for power tools

(76) Inventors: Matthew A. Smith, Jackson, TN (US); David V. Keller, Jackson, TN (US); Jaime E. Garcia, Jackson, TN (US); Jeffrey D. Weston, Jackson, TN (US)

Correspondence Address: THE BLACK & DECKER CORPORATION, 701 EAST JOPPA ROAD, TW199, TOWSON, MD, 21286, US

(21) Appl. No.: 10/797,486

(22) Filed: Mar. 10, 2004

Related U.S. Application Data
(60) Provisional application No. 60/453,299, filed on Mar. 10, 2003.

(51) Int. Cl. B26D 5/00

(52) U.S. Cl. 83/58

(57) ABSTRACT

The present invention is directed to a power tool including a working element for performing a task. A light source is arranged to project a beam of light adjacent the working element. A detector, such as an electro-optic type detector, is communicatively coupled to the power tool such that the detector is capable of detecting the presence of a human body part in the beam of light. If a body part is detected, the detector may communicate to stop operation of the working element.

### CROSS REFERENCE

The present application claims priority under 35 U.S.C. §119(e) to U.S. Provisional Patent Application Ser. No. 60/453,299, entitled: Optical Proximity Device for Power Tools, filed on Mar. 10, 2003, which is hereby incorporated by reference in its entirety.

### FIELD OF THE INVENTION

The present invention generally relates to the field of power tools, and particularly to a device for preventing user contact with a working tool, such as a saw blade, included in a power tool.

### BACKGROUND OF THE INVENTION

Traditionally, power tools have utilized mechanical guards to prevent the user from contacting working tool elements, such as saw blades, shaping knives, bits, and the like. Recently, power tools such as table saws have included systems for stopping the blade upon human contact. For example, a circular saw blade is statically charged, thus if the user contacts the blade the resultant discharge is utilized to initiate a stopping procedure. The obvious disadvantage to this device is that blade contact with the human hand is required to initiate blade braking action. Another disadvantage is the considerable damage that is caused by the violent thrusting of a sacrificial aluminum braking block into the teeth of a rotating blade.

Therefore, it would be desirable to provide an optical proximity device, which does not require blade contact to halt the machine's working tool.

### SUMMARY OF THE INVENTION

Accordingly, the present invention is directed generally to a device for determining the presence of a human body part such that a working element may be stopped or a device locked from use upon detection of the presence of a human body part.

In an aspect of the present invention, a power tool includes a working element for performing a task. A light source is arranged to project a beam of light adjacent the working element. A detector such as an electro-optic type detector is communicatively coupled to the power tool so that the detector is capable of detecting the presence of a human body part in the beam of light. If a human body part is detected, the detector may communicate to stop operation of the working element such as by implementing a passive stopping technique or by implementing a countermeasure device.

In a further aspect of the invention, an optical proximity device for use with a saw includes a source arranged to project a beam of light adjacent a circular saw blade and a electro-optical detector configured to detect the presence of a human body part in the beam of light. The detector is communicatively coupled to the saw such that if a body part is detected in the beam the rotation of the saw blade is stopped such as by implementing a passive stopping technique or by implementing a countermeasure device.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a perspective view of a table saw in accordance with an aspect of the present invention;

FIG. 2 is a cut-away view of an optical proximity device included on the table saw;

FIG. 3 is a cut-away view of an optical proximity device, configured with two zone detection, included on the table saw;

FIG. 4 is a side elevation view of an optical proximity device illustrating projection and reflectance of energy;

FIG. 5 is a cut-away view of an optical proximity device included on the table saw wherein a user's hand is within a detection zone defined by projected light;

FIG. 6 is a simplified perspective view of a saw assembly including a mechanical break for stopping operation of a saw blade; and

FIG. 7 is an end cut-away view of an arbor assembly included in a table saw, wherein the arbor assembly includes two solenoids for removing an associated saw blade below a support surface if a human body part is detected.

### DETAILED DESCRIPTION OF THE INVENTION

Those of skill in the art will appreciate that the apparatus of the present invention may be implemented with various power tools to prevent contact with an operating working element/to lockout a tool from use (prevent use). Those of skill in the art will appreciate that the optical proximity device in accordance with the present invention may be included on various power tools such as band saws, scroll saws, chop saws, miter saws, circular saws, panel cutters, planers, joiners, shapers, drill presses, grinders, drills, pneumatic fasteners, combustion fasteners, routers, cut-off tools, reciprocating saws, and the like.

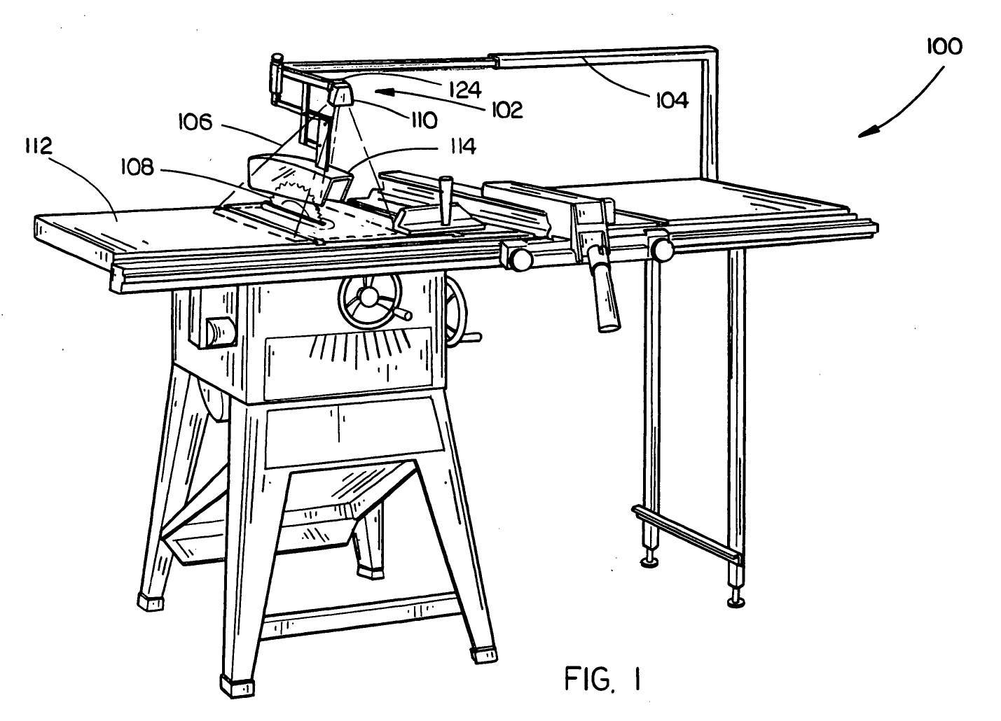

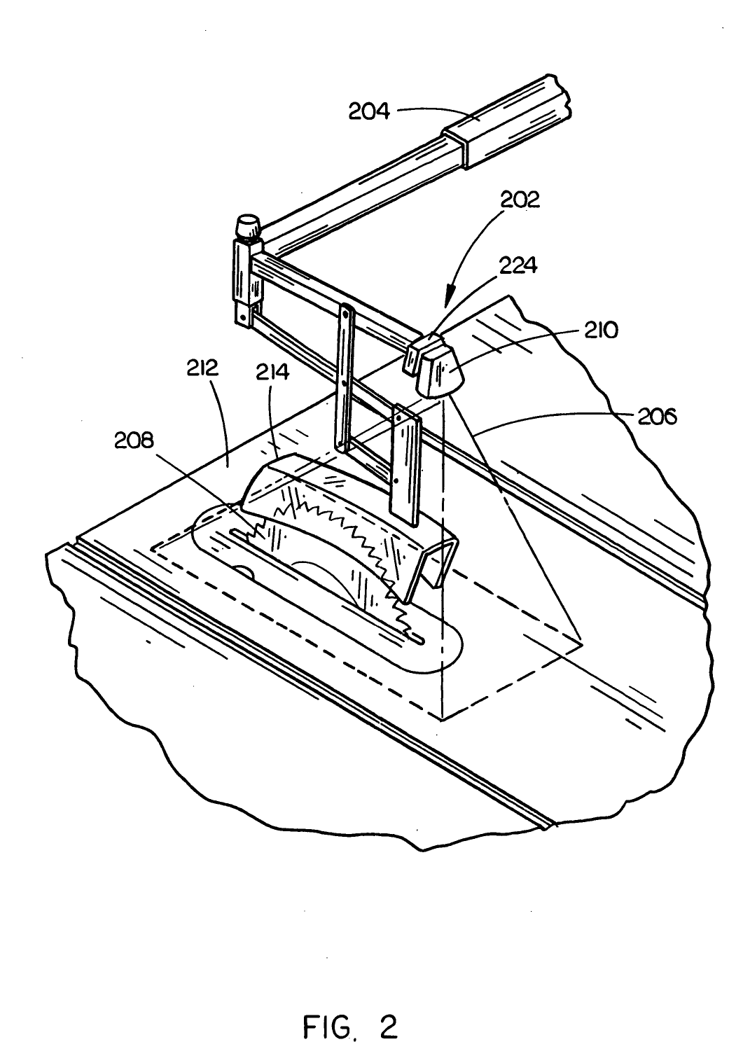

Referring to FIGS. 1 and 2 (wherein like numerals refer to like components), a table saw 100 in accordance with an aspect of the present invention is disclosed. In the present embodiment, an optical proximity device 102 is mounted to an over-arm type blade guard 104. In additional embodiments, an optical proximity device 102 may be positioned as desired so as to adequately project/detect the existence of a body part (such as a hand, a portion of a hand or the like) in a beam of light. Suitable mounting locations include, back splitters, riving knives, mounting the optical proximity device over the tool (such as from a ceiling which may be communicatively coupled via a wireless communication system, or the like), on a guide fence, and the like. Preferably, various mechanical safety devices such as mechanical guards (including blade guards/back splitters/riving knifes/anti-kick back pawls) may be included to direct dust and debris, and to prevent binding. When utilized with an optical proximity device, slots may be included in a guard 114 to allow for the passage of the light beam. Alternately, a guard may be utilized which is transparent (does not absorb energy) for the wavelength or wavelengths of light utilized or if the spectral signature of the guard (i.e., typically visually transparent plastic) is sufficiently different from that of human tissues to allow for recognition. In the current embodiment, the light source 110 is projected beyond the guard 114. Those of skill in the art will appreciate that the light beam projected by a light source may be varied depending on the orientation, size, projection angle, reflection angle, and the like characteristics. Various factors impacting the desired characteristics of a light beam include increasing the returned signal (such as energy reflected to a detector), minimizing dust interference, allowing for appropriate stopping time (such as to account for the time required to either actively or passively stop the working element) and the like.

Preferably, an optical proximity device 102 includes a light source 110 configured to project a beam of light 106 forming a zone adjacent a working element such as a band saw blade, a drill bit, a cutter head, a router bit, a circular saw blade 108, or the like, by projecting a cone (a pyramidal cone is illustrated) of light generally about a portion of the saw blade 108 extending beyond a support surface 112 included in the table saw 100. In alternate embodiments, an optical proximity device 102 may include a light source 110 configured to raster a beam in a zone, or raster along a path, split the beam/utilize mirrors to direct the energy, or the like. Alternatively, an optical proximity device may define a line, a point (e.g., a relatively focused beam). In further examples, a plurality of optical proximity devices are utilized to define several points generally about a working element such as a circular saw blade 108 mounted to an arbor. For example, it may be preferable if one or more point beams are disposed about the interface of the working element and a workpiece. In a further example, a light source may project a fan beam of light so as to project a line. In an embodiment, a light source may project a beam of light along a side of the blade or multiple light sources utilized to define a perimeter. Those of skill in the art will appreciate the beam may be spaced sufficiently away from the working element or project a sufficiently wide beam to allow for application of an appropriate stopping technique (either passive or active technique) such as merely turning-off the power tool's motor, applying an electric brake, applying a mechanical brake, utilizing a sacrificial brake such as by driving a block of metal into the blade (e.g., aluminum), removing the working element (e.g., dropping the arbor/saw blade below the workpiece support surface of a table saw, and the like) for preventing contact between a user and the operating working tool. For example, if a passive technique is utilized it may be preferable to space the projected light further away from the working element in comparison to an active stopping technique. Additional factors for light source arrangement include common techniques to be implemented by the tool, the projected user actions, or the like.

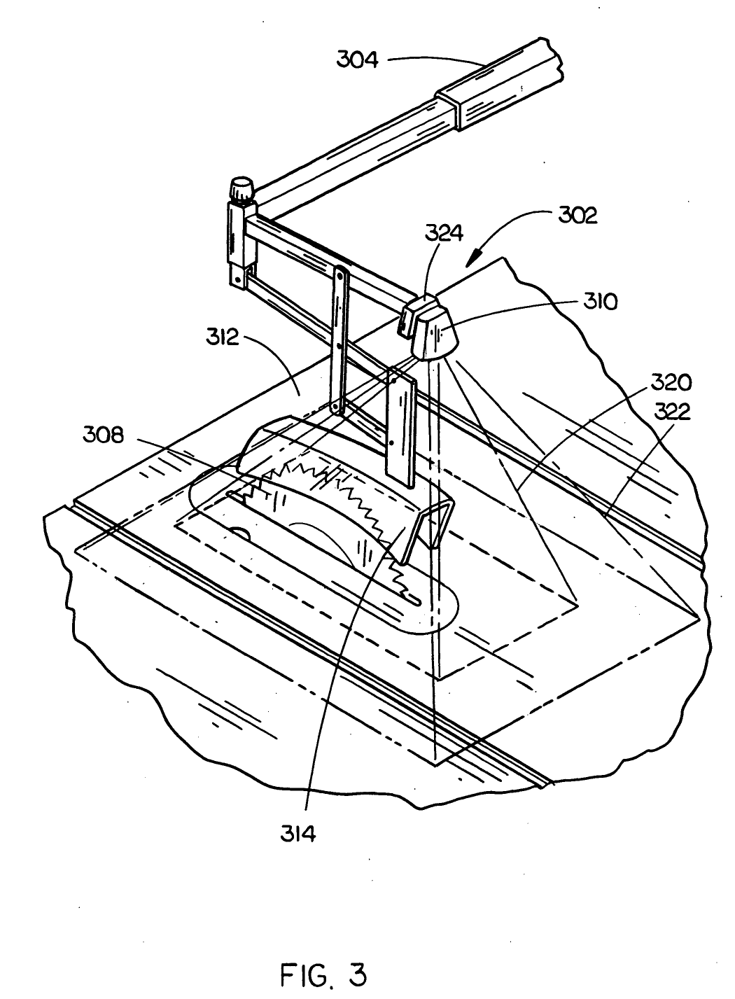

Referring now to FIG. 3, in a preferred embodiment, an optical proximity device 302 may be configured to implement multiple zones (for example a two zone system) such that a passive braking technique may be utilized if a human body part is detected in an outer zone 322 (such as relatively away from the working tool) and an active technique may be triggered if a human body part is detected in an inner zone 320 (such as in close proximity to the working element) (it is to be apparent in both cases that the relative terms are to be considered with respect to the overall power tool, the techniques implemented by the power tool and the like). Those of skill in the art will appreciate that a multiple zone system may utilize additional optical proximity devices, a single light source with more than one detector, utilize one optical proximity device which is capable of differentiating between spatial locations. For example, a detector 324 may be capable of providing a varying response based on the location at which the body part is detected. In additional examples, a multiple zone system may allow for an outer passive zone to be disabled such as when cutting a tenon utilizing a tenon jig utilizing a table saw while maintaining an enabled active braking system.

Additionally, a light source may be utilized which includes a coherent light source such as a laser, (e.g. a diode laser, fiber optics transmitting laser light) as a reference for detection such as a helium-neon (HeNe laser). In the previous system, the laser light may be utilized as a reference, or for other spectroscopic purposes and/or to indicate the location of the projected light beam. For example, a HeNe laser may be utilized along with an infrared source to optimize detection.

In further embodiments, an indicator may be included for providing a visual indicator of a detection/warning zone. Suitable indicators include coherent light indicators such as laser indicators (e.g. a diode laser, fiber optics transmitting laser light) and the like. Inclusion of a visible indicator may assist in minimizing inadvertent tripping of the system, encourage safe habits, and the like.

Suitable light sources include an infrared (IR) source, a near-infrared source, a combination near-infrared (near-IR)/infrared source, a visible light source, a combination near-infrared/visible source, an ultraviolet source, a combination ultraviolet/visible (UV-Vis) source, and a far-infrared source. In a preferred embodiment, a near-IR source is utilized to minimize expense, allow for proper detection, allow for a compact system, and the like. For example, a fiber optic probe may be utilized to transmit the desired wavelength/wavelengths of light. Those of skill in the art will appreciate that the exact wavelength of energy or wavelengths may be selected based on the desired absorption/non-absorption. For example, a range of wavelengths may be selected due to the prevalence of strongly absorbing/non-absorbing molecular structures in human tissues in the wavelength range. In a further example, a particular wavelength may be selected due to a strong interaction (such as a strong asymmetrical twist, rocking, stretch or the like) with molecular bonds included in molecules found human tissue which is not prevalent in a typical workpiece such as wood, laminates, in the workpiece support surface, and the like. Those of skill in the art will appreciate that while a molecular level detection described, detection may be also based on other structural levels in further embodiments. In further examples, a range of wavelengths may be scanned or the like.

Additionally, a lateral adjustment device (such as a slide mechanism, a threaded rod, or the like for adjusting the lateral position of the projected light) or a skew correction device (for properly aligning the projected light with the working element (suitable skew correction devices include pivot pins, screws, bolts, push pins adjustable clamps or the like)) may be included with the light source for adjusting the location of the projected light beam. For instance, utilizing a lateral adjustment device and a skew correction device may allow a user to align the projected beam of light in an X-Y coordinate system with respect to a working element.

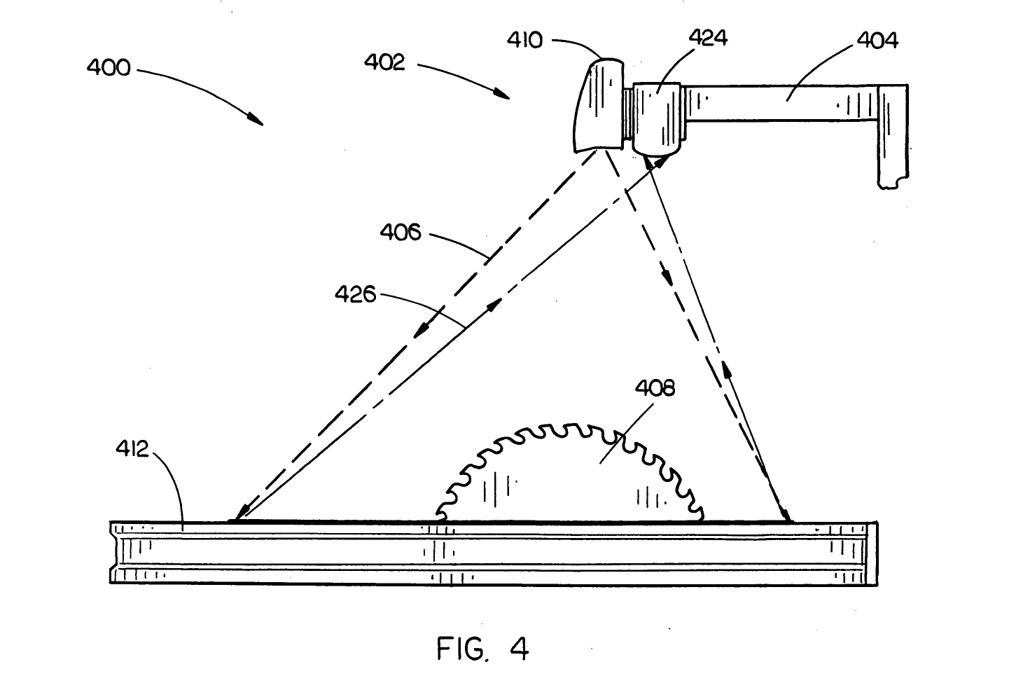

Referring to FIG. 4, a detector 424 is included in an optical proximity device 402. The detector 424 is constructed to detect the presence of a human body part in a beam of light projected by a light source 410. For example, a diffuse reflectance near-infrared detector is utilized in conjunction with a near-infrared source 410 to detect the presence of molecular structures associated with human tissues. Preferably, the source/detector may be configured as a probe included on an optical fiber which may be positioned so as to detect the presence of body part adjacent the circular saw blade 408. Preferably, a detector 424 is optimized in conjunction with the corresponding light source. For example, a reflectance infrared detector may be utilized with an infrared source. A detector may be remotely positioned from a corresponding light source to allow for increased signal return for the system, account for a desired angle of return, minimize dust interference, or the like. Those of skill in the art will appreciate that various electro-optical detectors (which utilize various spectroscopic techniques) may be implemented based on cost effectiveness, site conditions, durability, ease of use, reliability, susceptibility to dust interference, and the like. For example, an Indium-Gallium-Arsenic type detector may be utilized to detect molecular structures associated with human tissue associated in wavelengths in the near-infrared region. The foregoing system may implement reflectance or diffuse reflectance detection. Alternatively, a particular wavelength, or narrow range of wavelengths, may be selected as representative of a human body part. Additionally, the detector 424 may be configured to allow for detection materials commonly used in gloves which may be worn by a woodworker. For example, a range of wavelengths may be selected such that if a user wears leather gloves, or the like, the detector may determine if the user's hand is within a beam of light. In further embodiments, mirrors may be utilized to focus the returned energy 426 signal (such as from human tissue or a wood workpiece).

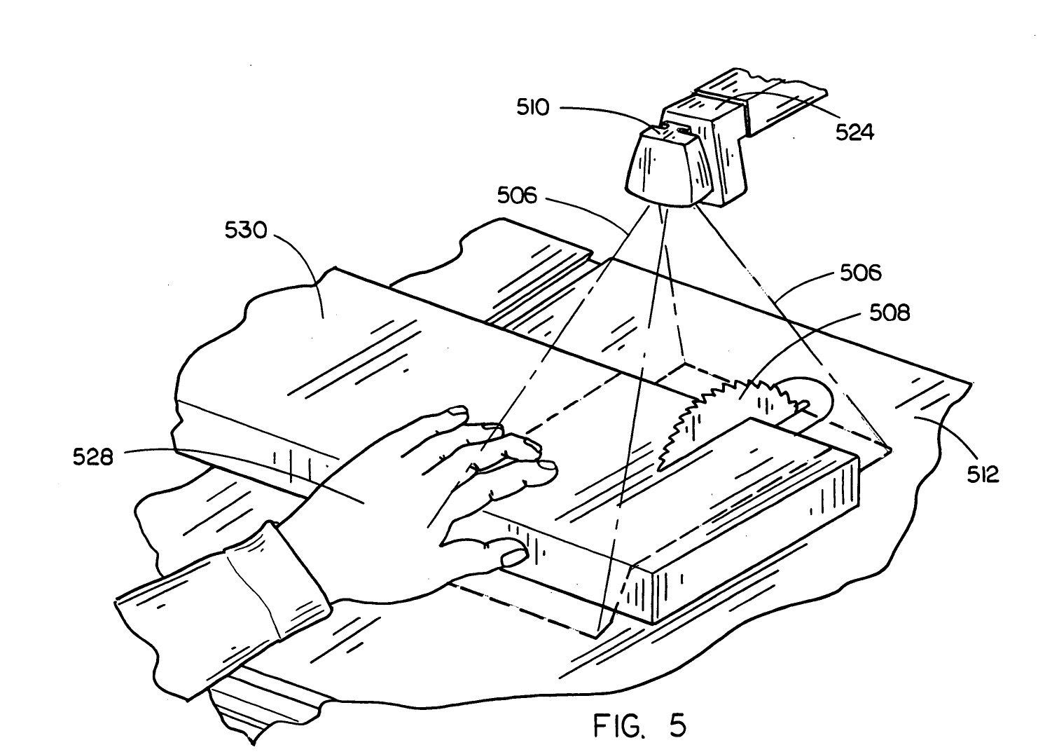

Referring to FIGS. 4 and 5, preferably, a detector 524 is configured to act generally as a switch such that if a human hand 528 is disposed in a light beam projected by a light source 510 the detector 524 is communicatively coupled so as to stop operation of the working element (e.g., a circular saw blade 508). Suitable detectors include reflectance based techniques such as reflectance or diffuse reflectance (e.g., far-infrared, near-infrared, infrared, or a combination thereof) or the like where reflected energy is detected. In additional embodiments, a detector may include analyzer hardware and/or software for conducting analysis of the return signal. For example, an optical proximity device includes a detector configured to analyze a range of wavelengths to determine the presence of a human hand in the projected light beam. In further embodiments, a separate analyzer is included to evaluate the return signal 426. For example, the detector may scan a range of wavelengths or merely detect in at a predetermined wavelength or narrow band of wavelengths. In the previous example, if a specific wavelength is selected the source may be simplified or configured to project additional energy at a corresponding energy range.

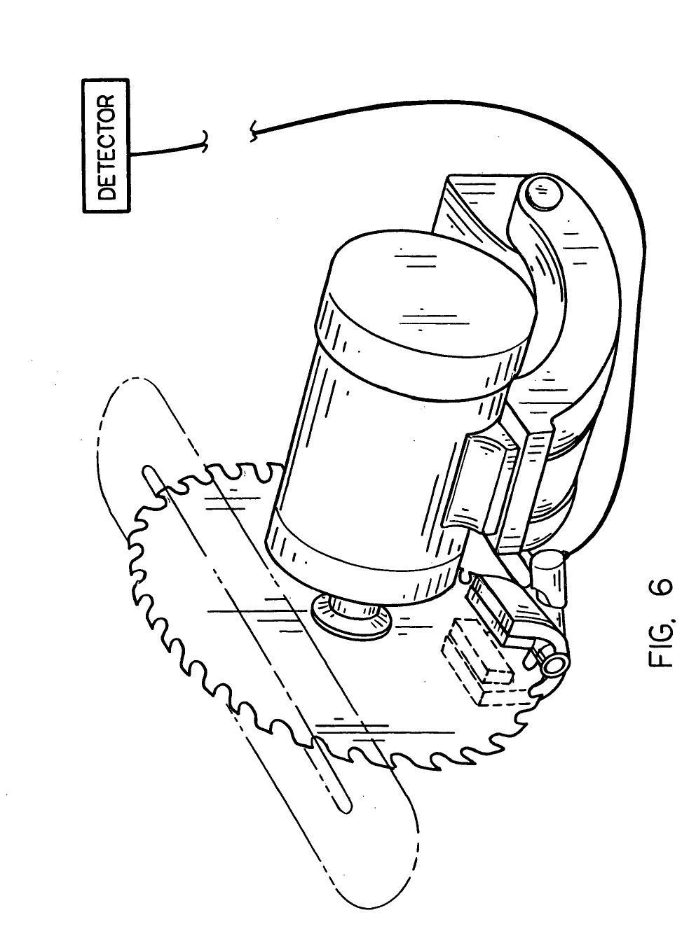

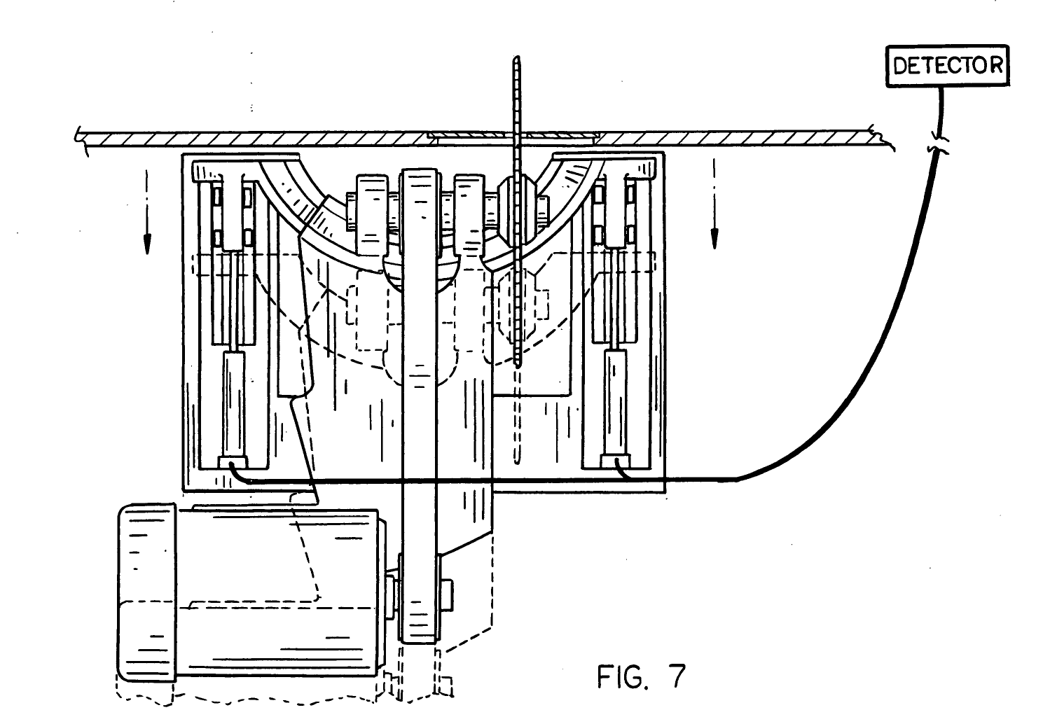

With continued reference to FIG. 5, if a detector 524 detects the presence of a human body part such as a hand 528 in the beam of light 506, the detector 524 communicates or signals to initiate stopping the blade 508. The detector 524 may be coupled to the appropriate power tool component (e.g., a motor, an electric brake, a removal device) via a wired connection, or utilize a wireless connection. The detector 524 may initiate a passive stopping technique such as by “turning off” (or preventing energy from reaching the power tool's motor) the motor driving the saw blade 508, or the like for passively preventing a user from contacting an operating saw blade 508. In further embodiments, a countermeasure device for conducting an active stopping technique is implemented. Examples of suitable countermeasure devices include mechanical breaks (as seen generally in FIG. 6), electric motor brakes (preferably in conjunction with turning-off the motor), sacrificial breaks (e.g., a brake which stops the saw blade by damaging the working element) (for example an aluminum block which contacts a circular saw blade's teeth), a removal device (as seen generally in FIG. 7), a device which blocks user contact, or the like for actively stopping the working element. For example, a detector 524 may be communicatively coupled to a saw's motor in order to prevent the motor from driving the saw blade 508. If a two zone system is utilized the detector may be communicatively coupled to the saw motor as well as a mechanical brake (such as opposing brake calipers) for engaging the saw blade 508. For example, a solenoid may activate to drive opposing brake arms to engage the saw blade 508. In a preferred embodiment, an optical detector 524 is configured to initiate a passive stopping technique a remote position (relative the working tool) and an active technique at proximal position such as near the working tool than the remote position. Alternately, a biasing device which is arrested by an extended solenoid may be included. Preferably, a brake pad with a sufficiently high coefficient of friction may be utilized to stop the working element without damaging the working element. In further embodiments, a pyrotechnic operated mechanical or a sacrificial brake may be utilized. Referring to FIG. 7, in a preferred embodiment, an arbor assembly including an arbor for mounting a circular saw blade is constructed such that a solenoid or a pyrotechnic charge may drive the arbor assembly away from a user (remove the working element away from the user) such as below a workpiece support surface. While a passive or non-destructive countermeasure device is preferable a sacrificial braking system may be employed depending on detection distance or the like. Those of skill in the art will appreciate that various devices may be implemented to stop the working element without departing from the scope and spirit of the present invention.

In a further aspect, an optical proximity device may be additionally utilized to indicate the kerf of the saw blade or a side of the channel cut in a workpiece by operation of the saw blade. For example, if a coherent light source is included in an optical proximity device, a visual indication may be made indicating where the teeth of a saw blade will enter the workpiece on a side such as by projecting a line of light including a side which may be aligned with the kerf formed by the saw blade. In the previous example, a beam may be sufficiently wide to allow for detection at a sufficient distance to allow for passive stopping of the working tool, multiple sources may be utilized, or a source rastered.

It is believed that the apparatus of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A power tool, comprising:
a working element for performing a task on a workpiece;
a light source arranged to project a beam of light adjacent the interface between the working element and the workpiece; and
a detector configured to detect the presence of a human body part in the beam of light,
wherein the detector is communicatively coupled to the power tool so as to stop operation of the working element, if a human body part is detected.

2. The power tool of claim 1, wherein the working element is at least one of a circular saw blade, a band saw blade, a drill bit, a cutter head, or a router bit.

3. The power tool of claim 1, wherein the light source is an infrared source, a near-infrared source, a combination near-infrared/infrared source, a visible light source, a combination near-infrared/visible source, an ultraviolet source, a combination ultraviolet/visible source, a coherent light source, or a far-infrared source.

4. The power tool of claim 1, further comprising a countermeasure device communicatively coupled to the detector, said countermeasure device being constructed for stopping the working element if a human body part is detected.

5. The power tool of claim 4, wherein the countermeasure device is a mechanical break, a sacrificial brake, an electric brake, or a removal device.

6. The power tool of claim 1, wherein the light source projects a zone generally about the working element.

7. The power tool of claim 1, further comprising an indicator configured to provide a visual indication of a detection zone.

8. A saw, comprising:
an arbor constructed for mounting a circular saw blade thereto;
a light source arranged so as to project a beam of light adjacent the circular saw blade; and
a detector configured to detect the presence of a human body part in the beam of light,
wherein the detector is communicatively coupled so as to stop the rotation of the circular saw blade, if a human body part is detected.

9. The saw of claim 8, wherein the light source is an infrared source, a near-infrared source, a combination near-infrared/infrared source, a visible light source, a combination near-infrared/visible source, an ultraviolet source, a combination ultraviolet/visible source, a coherent light source, or a far-infrared source.

10. The saw of claim 8, further comprising a countermeasure device communicatively coupled to the detector, said countermeasure device being constructed to prevent contact between the human body part and the circular saw blade if the saw is operating.

11. The saw of claim 10, wherein the countermeasure device is a mechanical break, a sacrificial brake, an electric motor brake, or a removal device.

12. The saw of claim 8, wherein the light source projects a beam of light defining a zone generally about the circular saw blade.

13. The saw of claim 8, wherein the projected light beam defines a point adjacent the circular saw blade.

14. The saw of claim 8, further comprising an indicator configured to provide a visual indication of a detection zone.

15. The saw of claim 8, wherein the light source is a near-infrared light source.

16. The saw of claim 8, wherein the detector is a diffuse reflectance electro-optical detector.

17. The saw of claim 8, wherein the detector is configured to detect the presence of a human body part in at least two discrete locations with respect to the circular saw blade.

18. The saw of claim 8, wherein the detector is configured to initiate passive stopping of the circular saw blade at a remote position and active stopping of the circular saw blade at a proximal position, based on detection of a human body part, with respect to the circular saw blade.

19. The saw of claim 8, wherein the light source and the detector are automatically re-enabled when the saw is activated.

20. The saw of claim 8, wherein the detector is an Indium-Gallium-Arsenic based detector.

22. The saw of claim 8, wherein the light source and the detector are configured as a fiber optic probe.

23. A table saw, comprising:
a support surface for at least partially supporting a workpiece;
an arbor constructed for mounting a circular saw blade thereto, said arbor being configured so as to extend the circular saw blade through the support surface;
a light source arranged to project a beam of light adjacent the circular saw blade; and
an electro-optical detector configured to detect the presence of a human body part in the beam of light,
wherein the detector is communicatively coupled to the saw so as to stop the rotation of the circular saw blade, if a human body part is detected.

24. The table saw of claim 23, wherein the light source is an infrared source, a near-infrared source, a combination near-infrared/infrared source, a visible light source, a combination near-infrared/visible source, an ultraviolet source, a combination ultraviolet/visible source, a coherent light source, or a far-infrared source.

25. The table saw of claim 23, further comprising a countermeasure device communicatively coupled to the detector, said countermeasure device being constructed to prevent contact between the human body part and the circular saw blade if the saw is operating.

26. The table saw of claim 25, wherein the countermeasure device is a mechanical break, a sacrificial brake, an electric motor brake, or a removal device.

27. The table saw of claim 23, wherein the light source projects a beam of light defining a zone generally about the circular saw blade.

28. The table saw of claim 23, wherein the projected light beam defines a point adjacent the circular saw blade.

29. The table saw of claim 23, further comprising an indicator configured to provide a visual indication of a detection zone.

30. The table saw of claim 23, wherein the light source is a near-infrared light source.

31. The table saw of claim 23, wherein the electro-optical detector is a diffuse reflectance electro-optical detector.

32. The table saw of claim 23, wherein the detector is configured to detect the presence of a human body part in at least two discrete locations with respect to the circular saw blade.

33. The table saw of claim 23, wherein the electro-optical detector is configured to initiate passive stopping of the circular saw blade at a remote position and active stopping of the circular saw blade at a proximal position, based on detection of a human body part, with respect to the circular saw blade.

34. The table saw of claim 23, wherein the light source and the electro-optical detector are automatically re-enabled when the saw is activated.

35. The table saw of claim 23, wherein the electro-optical detector is an Indium-Gallium-Arsenic based detector.

36. The table saw of claim 23, wherein the light source and the electro-optical detector are configured as a fiber optic probe.

37. An optical proximity device for a saw, comprising:
a light source arranged to project a beam of light adjacent to a circular saw blade; and
an electro-optical detector configured to detect the presence of a human body part in the beam of light,
wherein the detector is communicatively coupled to the saw so as to stop the rotation of the circular saw blade, if a human body part is detected.

38. The optical proximity device of claim 37, wherein the light source is an infrared source, a near-infrared source, a combination near-infrared/infrared source, a visible light source, a combination near-infrared/visible source, an ultraviolet source, a combination ultraviolet/visible source, a coherent light source, or a far-infrared source.

39. The optical proximity device of claim 37, further comprising a countermeasure device communicatively coupled to the detector, said countermeasure device being constructed to prevent contact between the human body part and the circular saw blade during operation.

40. The optical proximity device of claim 39, wherein the countermeasure device is a mechanical break, a sacrificial brake, an electric motor brake, or a removal device.

41. The optical proximity device of claim 37, wherein the light source projects a beam of light defining a zone generally about the circular saw blade.

42. The optical proximity device of claim 37, further comprising an indicator configured to provide a visual indication of a detection zone.

43. The optical proximity device of claim 37, wherein the electro-optical detector is a diffuse reflectance detector.

44. The optical proximity device of claim 37, wherein the electro-optical detector is configured to initiate passive stopping of the circular saw blade at a remote position and active stopping of the circular saw blade at a proximal position, based on detection of a human body part, with respect to the circular saw blade.

45. The optical proximity device of claim 37, wherein the light source and the electro-optical detector are automatically re-enabled when the saw is activated.

46. The optical proximity device of claim 37, wherein the electro-optical detector is an Indium-Gallium-Arsenic based detector.

47. The optical proximity device of claim 37, wherein the light source and the electro-optical detector are configured as a fiber optic probe.

46. An optical proximity device for a saw, comprising:
means for detecting the presence of a human body part in the beam of light projected adjacent a saw blade; and
means for stopping operation of the saw blade, if a human body part is detected in the light beam.

47. The optical proximity device of claim 46, wherein the stopping means includes a countermeasure device constructed to prevent contact between the human body part and the saw blade during operation.

48. The optical proximity device of claim 47, wherein the countermeasure device is a mechanical break, a sacrificial brake, an electric motor brake, or a removal device.

49. The optical proximity device of claim 46, further comprising an indicator configured to provide a visual indication of a detection zone.

50. The optical proximity device of claim 46, wherein the detecting means is a diffuse reflectance detector.
